(19) United States
(12) Patent Application Publication
(10) Pub. No.: US 2020/0248511 A1
(43) Pub. Date: Aug. 6, 2020

(54) TRAILER HAVING AN EXTENDABLE BOOM

(71) Applicant: CW10K40 LLC, Camden, DE (US)

(72) Inventor: Torsten Leines, Maple Grove, MN (US)

(73) Assignee: CW10K40 LLC, Camden, DE (US)

(21) Appl. No.: 16/263,592

(22) Filed: Jan. 31, 2019

(51) Int. Cl. E21B 19/15; B60P 1/16

(52) U.S. Cl. CPC E21B 19/155; B60P 3/40; B60P 1/16

(57) ABSTRACT

Aspects of the disclosure relate to trailers having an extendable boom on which sections of pipe or the like can be supported for transport and lift at a job site, such as an oil rig. The boom has a rearward portion and a forward portion. The forward portion is configured to fold under the rearward portion in a folded arrangement and can pivot away from the rearward portion into an extended, unfolded arrangement. In this way, an effective working length of the boom can be extended/shortened while the boom is in full operation and without having to separately transport and maintain an extension for the boom.

### BACKGROUND

Drilling rigs are known and used for identifying geologic reservoirs of natural resources, such as oil, for example, and also to create holes that allow the extraction of natural resources from those reservoirs. The extraction process begins by positioning the drilling rig over the site to be drilled. Drilling rigs can be mobile and driven from site to site or can also be more permanent structures positioned over the drilling site.

The process begins by drilling a hole deep into the Earth. A long drill bit attached to a section of “drilling string” is used for this purpose. After each section is drilled, a steel pipe slightly smaller than the hole diameter is dropped in and often cement is used to fill the outer gap. The steel pipe is called a casing and provides structural integrity to the drilled hole. As the drill bit progresses deeper, additional sections of pipe need to be added to the drilling string to allow the drill bit to move further into the Earth. Typically, workers standing on the drilling rig take the additional sections of pipe, one by one, and screw them onto the drilling string, as needed. The additional sections of pipe are delivered to the site and then raised one by one to the workers with a crane. Currently, oil rigs are accessed by workers from the ground with a step ladder.

The present disclosure addresses problems and limitations with the related art.

### SUMMARY

Aspects of the disclosure relate to a trailer having a frame for supporting and transporting a section of pipe or other item. The trailer includes a boom which may be raised from the trailer and used to move the pipe to or from the trailer to a storage or other location. For example, index arms may move the pipe from a ground storage rack to the boom, where a skate may push the pipe along the length of the boom toward the rig. Or, the pipe may be moved from the rig to the boom, where the skate allows controlled downward movement of the pipe to where the pipe may be moved from the boom back onto ground storage racks. The boom has a rearward portion and a forward portion. The forward portion is configured to fold under the rearward portion in a folded arrangement and can pivot away from the rearward portion into an extended, unfolded arrangement. In this way, an effective working length of the boom can be extended/shortened while the boom is in full operation and without having to separately transport and maintain an extension (i.e. the forward portion) for the boom. The boom is raised and lowered in part by a travel height truss, which in turn is assisted by a lift assist assembly. The lift assist assembly provides greater leverage than would otherwise be available for the maximum size and weight of the boom available for a given (fixed) maximum length of trailer.

Embodiments of the disclosure are particularly useful for raising booms used to lift pipe sections used in oil drilling. In such embodiments, the frame can be driven to a job site, and the boom extended to its full height to enable removal of the pipe sections or other items from the trailer. Embodiments of the disclosure provide a safe and stable, yet more versatile trailer because they permit the boom to raise the pipe sections to greater height than trailers without the inventive features.

In one aspect, the disclosure provides a trailer comprising a frame, a hitch secured to the frame and an extendable boom. The boom includes a rearward portion having a first end and a second end and the boom also includes a forward portion pivotally connected to the second end. The boom has a folded arrangement in which the forward portion is folded underneath the rearward portion and an unfolded arrangement in which the forward portion is coplanar with the rearward portion. The trailer further includes a first hydraulic system configured to raise and lower the boom with respect to the frame.

In another aspect, the disclosure provides a method of operating a trailer. The method includes providing a trailer having a frame, a hitch secured to the frame and an extendable boom. The boom includes a rearward portion having a first end, a second end and a forward portion pivotally connected to the second end. The boom has a folded arrangement in which the forward portion is folded under the rearward portion and an unfolded arrangement in which the forward portion is coplanar with the rearward portion. The trailer further includes a first hydraulic system configured to raise and lower the boom. The method further includes the step of raising the first end of the rearward portion with respect to the second end of the rearward portion and positioning the forward portion in the unfolded arrangement, however, the forward portion can also remain in the folded arrangement.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. Like reference numerals designate corresponding similar parts.

FIGS. 1A-1B are perspective views collectively illustrating a trailer of the disclosure having an extendable boom.

FIG. 2 is a side view of the boom of FIG. 1, the boom having a rearward portion and a forward portion; wherein the forward portion is shown in a variety of positions with respect to the rearward portion.

FIG. 3 is a side view of the boom of FIGS. 1-2 shown in a fully unfolded arrangement.

FIG. 4 is an enlarged view of a portion of FIG. 3.

FIG. 5 is a side view of the boom of FIGS. 2-4 in a partially unfolded arrangement.

FIG. 6 is an enlarged view of a portion of FIG. 5 having a housing of the rearward portion and the forward portion illustrated as partially transparent for ease of illustration.

FIG. 7 is a side view of the boom of FIGS. 2-4 in a second partially unfolded arrangement.

FIG. 8 is an enlarged view of a portion of FIG. 7 having the housings of the rearward portion and the forward portion illustrated as partially transparent for ease of illustration.

FIG. 9 is a side view of the boom of FIGS. 2-4 in a folded arrangement in which the forward portion is positioned underneath the rearward portion.

FIG. 10 is an enlarged view of a portion 10 of FIG. 9 having the housings of the rearward portion and the forward portion illustrated as partially transparent for ease of illustration.

FIG. 11 is a bottom view of the boom of FIGS. 1-10 in the fully unfolded arrangement of FIG. 3.

FIG. 12 is an enlarged view of a portion of FIG. 11 having the housings of the rearward portion and the forward portion illustrated as partially transparent for ease of illustration.

### DETAILED DESCRIPTION

In the following detailed description, reference is made to the accompanying drawings, which form a part hereof, and in which is shown by way of illustration specific embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

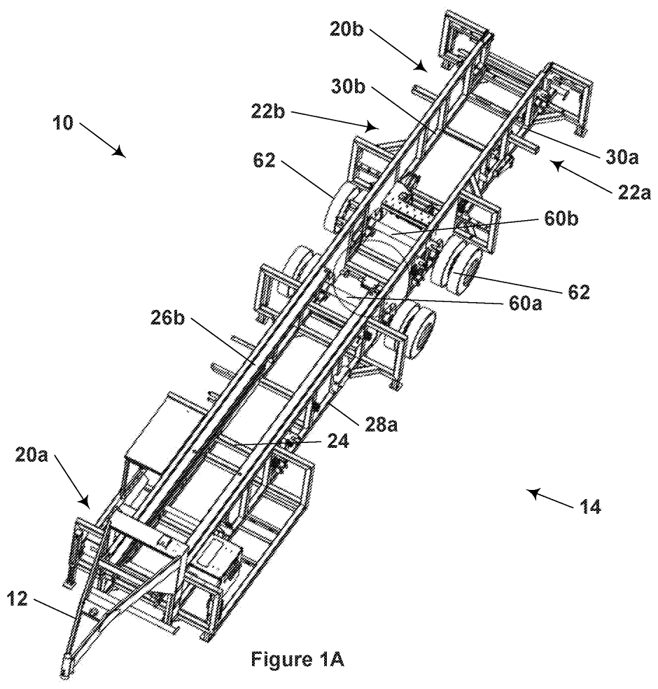

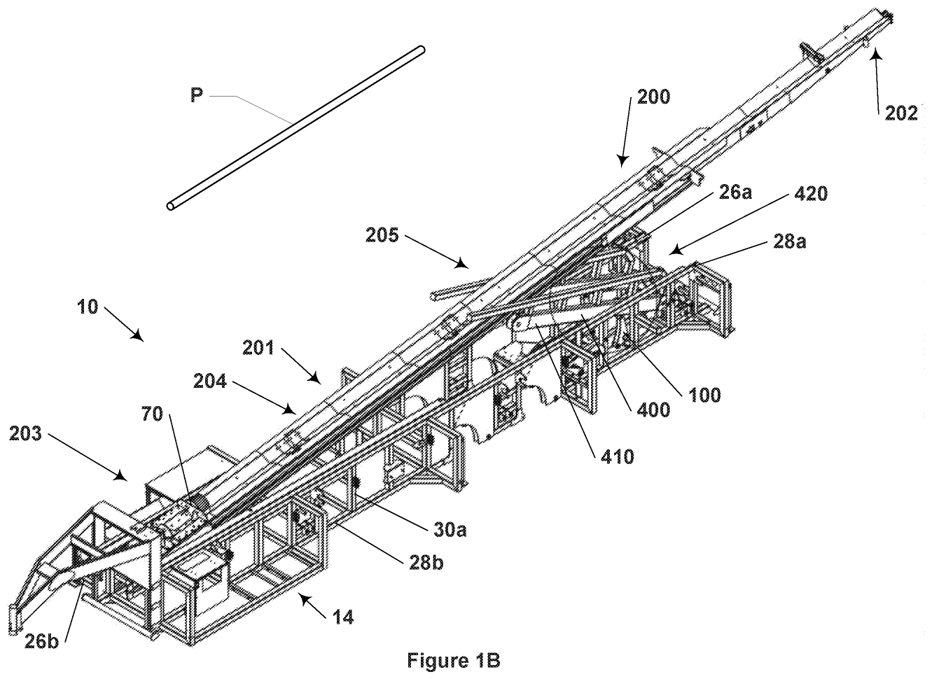

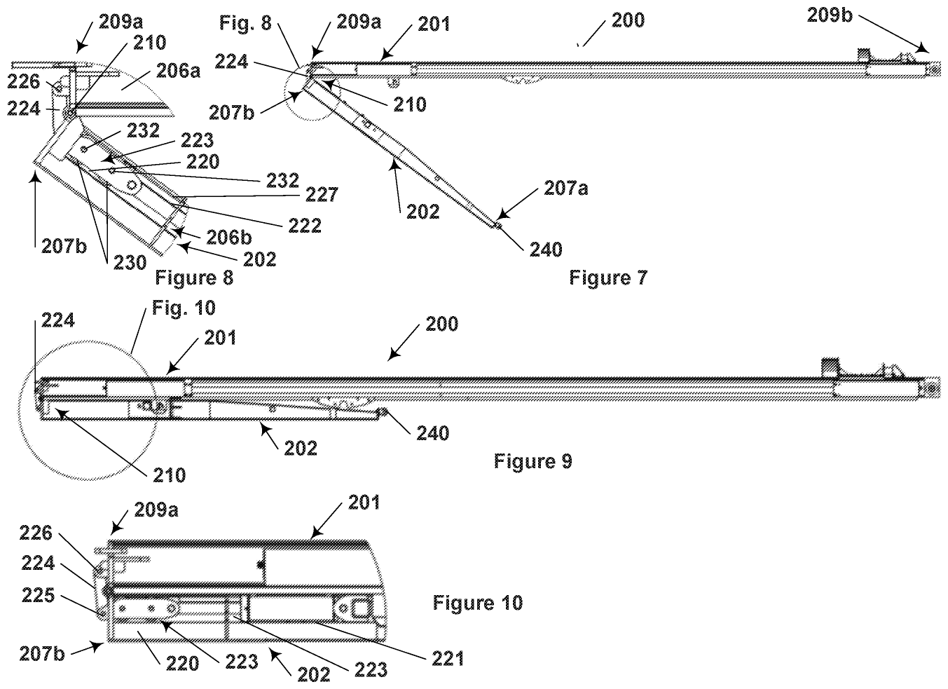

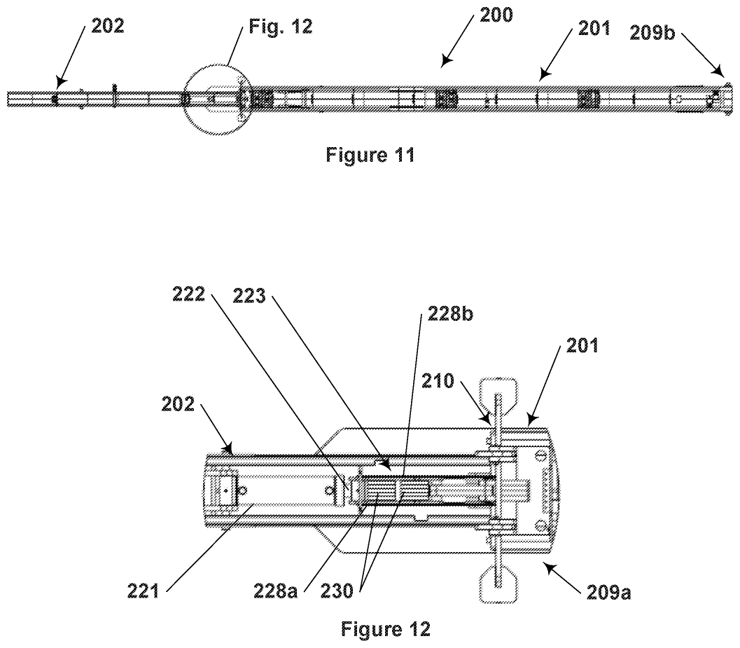

One illustrative trailer 10 is collectively illustrated in FIGS. 1A-12. As shown there, and particularly referring to FIGS. 1A-1B, the trailer 10 includes a hitch 12 for securing to a vehicle (not shown), such as a truck, as well as a frame 14 interconnected to the hitch 12. The frame 14 can take a variety of forms, as desired, and supports an item to be transported.

In one example, the item to be transported is a boom system usable to lift pipe sections P suitable for oil drilling. The frame 14 can, for example, include first and second ends 20a, 20b, first and second sides 22a, 22b, and multiple bottom supports 24 spanning the first and second sides 22a, 22b. Each side 22a, 22b can include a top 26a, 26b and a bottom 28a, 28b and include multiple vertical supports 30a, 30b spanning the respective top 26a, 26b and bottom 28a, 28b. It is noted that only a few representative horizontal supports 24 and vertical supports 30a, 30b are referenced for ease of illustration. The present disclosure, however, is not intended to be limited to any particular configuration of frame 14.

Interconnected to the frame 14 is at least one axle 60a, 60b operatively supporting at least one wheel 62 on opposing sides 22a, 22b of the frame 14. The wheels 62 can be any type commonly used for trailers, trucks or the like. In the illustrated embodiment, the trailer 10 includes first and second axles 60a, 60b, each axle 60a, 60b supporting two wheels 62 on opposite sides 22a, 22b of the frame 14.

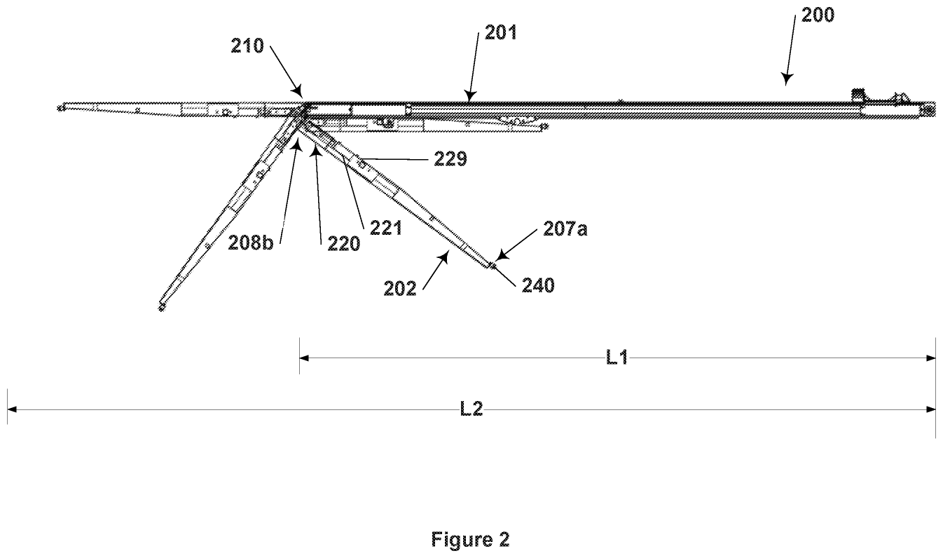

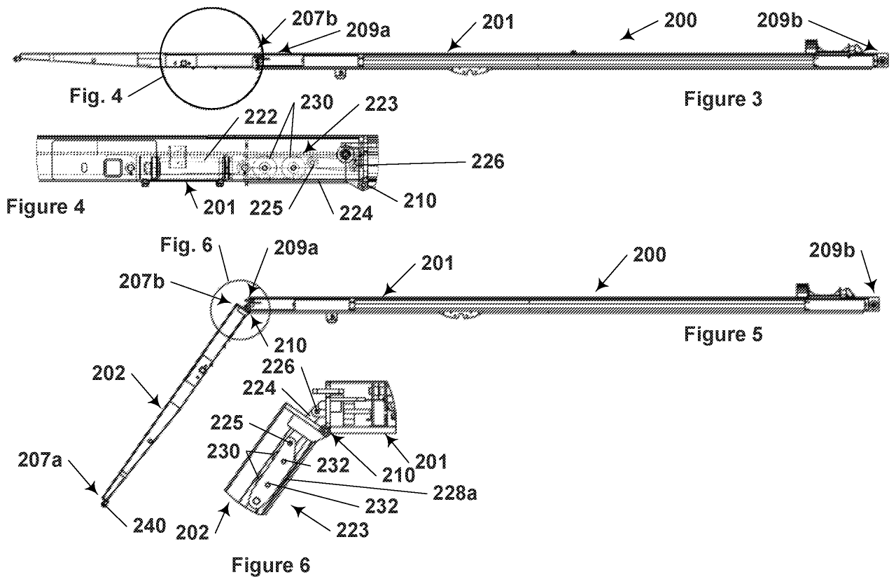

As shown in FIG. 1B, trailer 10 has a frame 14 which supports an extendable boom 200 pivotally connected to the frame 14 at pivot point 70 so that the boom 200 can be raised and lowered at an angle with respect to the frame 14. The boom 200 has a rearward portion 201 and a forward portion 202. In one example embodiment, the rearward portion 201 has a length L1 in the range of about 15 to about 25 feet and the forward portion 202 has a length L2 in the range of about 40 to about 60 feet. The aforementioned ranges are particularly useful for embodiments used with oil drilling pipe, however, the present disclosure is not intended to be limited to a boom having any particular dimensions. The rearward portion 201 has a first end 209a and a second end 209b. The forward portion 202 also has a first end 207a and a second end 207b. Both the rearward portion 201 and the forward portion 202 are generally tubes or housings defining respective inner lumens 206a, 206b. The second end 208 of the forward portion 202 is pivotally connected to the first end 209a of the rearward portion 201 to allow the forward portion 202 to either be folded underneath the rearward portion 201 (FIG. 10) or pivoted away from the rearward portion 201 (FIG. 3) to extend an effective working length of the boom 200 to accommodate larger sections of pipe, for example. As is best shown in FIG. 2, the boom 200 can be positioned in a plurality of intermediate arrangements or positions between the folded arrangement and the fully unfolded arrangement in which the forward portion 202 is partially unfolded with respect to the rearward portion 201. In the intermediate positions, for the operation of moving pipe, the forward portion 202 can be either fully folded underneath the rearward portion 201 or unfolded, as desired. In one embodiment, the forward portion 202 pivots about hinge 210 approximately 180 degrees (e.g., within +/−5 degrees of 180 degrees) as the forward portion 202 transitions from the folded arrangement to the unfolded arrangement and vice versa. In one illustrative example, the forward portion 202 is pivotally connected at hinge 210.

To actuate movement of the forward portion 202 with respect to the rearward portion 201, the boom 200 can include a slide assembly linkage 220 secured to a dual acting hydraulic cylinder (or “cylinder”) 221 having a piston rod 222 connected to the boom 200 with a mount 229. In one example the dual acting cylinder 221 has the following specifications: 5 inch bore, 14 inch stroke, 25 inch retraction and 1.5 inch pint diameter. The slide assembly linkage 220 includes a roller assembly 223 and a link 224. The link 224 includes a first hinged end 225 and a second end 226. The first hinged end 225 is connected to the roller assembly 223 and the second end 226 is connected to the rearward portion 202. The roller assembly 223 is also attached to the hydraulic cylinder 221 so that movement of the hydraulic cylinder 221 translates to the roller assembly 223 to move the roller assembly 223 within the lumen 206b of the forward portion 202.

In one embodiment, the roller assembly 223 is housed within a formed tube 227 positioned within the forward portion 202. The roller assembly 223 includes first and second plates 228a, 228b that support one or more rollers 230 (e.g., two rollers) rotatably mounted to each plate 228a, 228b with respective bolts or pins 232. As the cylinder 221 extends, the cylinder 221 folds the forward portion 202 about hinge 210 from the position of FIG. 3 to the position of FIG. 10. As the cylinder 221 extends, the roller assembly 223 correspondingly is pushed or pulled to slide within the formed tube 227. The roller assembly 223 pushes against the link 224 and the forward portion 202 rotates about hinge 210 from the position of FIG. 3 to the position of FIG. 10. As the cylinder 221 retracts, the forward portion 202 unfolds from the position of FIG. 10 to the position of FIG. 3.

The forward portion 202 can optionally include a roller 240 at the first end 207 of the forward portion 242 to allow transported pipes or the like to travel down the boom 200 if the boom 200 is oriented at a low angle due to decreased friction.

As indicated above, in general, boom 200 is mounted to frame 14 so that the rearward portion 201 of boom 200 may be elevated substantially above trailer 10 and frame 14 while the forward portion 202 remains generally in place vertically. To increase the angle above vertical which boom 200 may make with the generally horizontal plane of the frame 14, and thus increase the height to which rearward portion 201 may reach for a given length of boom 200, the forward portion 202 both pivots about an axis transverse to the length of frame 14, and translates from a forward position or location (indicated at 203) to a rearward position or location (indicated at 204) (see FIG. 1B).

Boom 200 is elevated from frame 14 by the action of travel height truss 400. Like boom 200 itself, travel height truss 400 is mounted to frame 14 so that one end of it may pivot above frame 14. Thus, a truss forward portion 410 of the travel height truss 400 may be elevated substantially above frame 14 while a truss rearward portion 420 of the travel height truss 400 remains generally in place vertically. The truss forward portion 410 is pivotably attached to boom 200 at a boom middle location 205. The angle above vertical which boom 200 makes with the generally horizontal plane of the frame 14 increases as the truss forward portion 410 of travel height truss 400 is elevated above frame 14. The elevation of truss forward portion 410 is accomplished by one or more hydraulic cylinders (not visible) arranged to cause travel height truss 400 to move relative to frame 14. Further details regarding the travel height truss 400 may be found in application Ser. No. 16/263,631 filed Jan. 31, 2019, copending, the disclosure of which is hereby incorporated by reference in its entirety.

In one preferred embodiment frame 14 is provided with at least one lift assist assembly 100 (e.g., one such assembly on each opposing side 22a, 22b of the frame 14). In general terms, each lift assist assembly 100 transfers force created along a generally longitudinal direction by one of a pair of dual acting hydraulic cylinders (not visible) each of which is coupled to its respective lift assist assembly 100. Each lift assist assembly 100 transfers the force to the vertical load of the travel height truss 400, lifting the truss forward portion 410 of the travel height truss 400 as the truss rearward portion 420 pivots in place relative to frame 14. A roller or other mechanism couples each lift assist assembly 100 to the travel height truss 400 in a manner that allows the point of contact to translate along the length of travel height truss 400 while maintaining application of the vertically directed force to travel height truss 400 as it rises above frame 14. The truss forward portion 410 thus rises above the frame 14. In particular, the travel height truss 400 is preferably raised above the point at which its lower surface lifts away from each lift assist assembly 100 (that is, it lifts off of each roller). But when the process is reversed and travel height truss 400 is lowered, it is desirable for each lift assist assembly 100 to be in this “fully raised” position. This allows each lift assist assembly 100 to share the load, and contribute to the controlled lowering, of travel height truss 400. That is, to lower the boom 200, the process is reversed and the hydraulic cylinder causes each lift assist assembly 100 to rotate clockwise and thus lower the travel height truss 400. In this process, each lift assist assembly 100 is initially not engaged with the bottom of the travel height truss 400, as noted above, but is subsequently engaged and therefore acts as a safety damper in at least two ways. First, by absorbing a portion of the load it carries, namely the weight of the combination of the boom 200 and travel height truss 400. Second, by slowing the rate at which the boom 200 is lowered.

The vertical force applied to travel height truss 400 by each lift assist assembly 100 is separate from and in addition to other force on the travel height truss 400 created by any separate hydraulic system acting directly on travel height truss 400. While a single system may coordinate the operation of the lift assist through the operation of the lift cylinder valve, in general these may be separately acting hydraulic systems which are coordinated with each other so as to act together. Thus, in some embodiments, the travel height truss 400 may have its own hydraulic cylinders and controls for raising it above the point at which its lower surface lifts away from the roller of the lift assist assembly 100. If so, the lift assist assembly 100 may be kept in its “fully raised” position so that it may contribute to the controlled lowering of travel height truss 400. Alternatively, it may be moved back to its “fully lowered” position in which it returns to its original configuration relative to the hinged travel height truss 400. It may then be returned to its “fully raised” position as part of the sequence of lowering the travel height truss 400. However, such a sequence is not required. Further details regarding the lift assist assemblies 100 including their configuration and operation may be found in application Ser. No. 16/263,553 filed Jan. 31, 2019, copending, the disclosure of which is hereby incorporated by reference in its entirety.

The description above describes the operation of a boom which was assumed to be manufactured as part of the original manufacture of trailer 10 and its associated loads and controls as described. However, a boom according to the principles of the disclosure may be retrofitted onto previously manufactured equipment.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. A trailer comprising:
a frame;
a hitch secured to the frame;
a boom including a rearward portion having a first end and a second end, the boom further including a forward portion pivotally connected to the second end; wherein the boom has a folded arrangement in which the forward portion is folded underneath the rearward portion and an unfolded arrangement in which the forward portion is coplanar with the rearward portion; and
a first hydraulic system configured to raise and lower the boom with respect to the frame.

2. The trailer of claim 1, wherein a second hydraulic system actuates movement of the forward portion of the boom with respect to the rearward portion of the boom.

3. The trailer of claim 2, wherein the second hydraulic cylinder is a dual acting hydraulic cylinder.

4. The trailer of claim 1, wherein the trailer further includes a slide assembly linkage including a roller assembly including a plurality of rollers.

5. The trailer of claim 3, wherein the slide assembly linkage includes a link, wherein the link is pivotally connected to both the roller assembly and the rearward portion.

6. The trailer of claim 3, wherein the rollers are positioned in the forward portion in the folded arrangement in the unfolded arrangement.

7. The trailer of claim 1, wherein the forward portion can pivot approximately 180 degrees with respect to the rearward portion.

8. A method of operating a trailer, the method comprising:
providing a trailer including:
a frame,
a hitch secured to the frame,
a boom including a rearward portion having a first end and a second end, the boom further including a forward portion pivotally connected to the second end; wherein the boom has a folded arrangement in which the forward portion is folded under the rearward portion and an unfolded arrangement in which the forward portion is coplanar with the rearward portion, and
a first hydraulic system configured to raise and lower the boom with respect to the frame;
raising the first end of the rearward portion with respect to the second end of the rearward portion; and
positioning the forward portion in the unfolded arrangement.

9. The method of claim 1, wherein a second hydraulic system actuates movement of the forward portion with respect to the rearward portion.

10. The method of claim 9, wherein the second hydraulic cylinder is a dual acting hydraulic cylinder.

11. The method of claim 8, wherein the trailer further includes a slide assembly linkage including a roller assembly including a plurality of rollers.

12. The method of claim 11, wherein the slide assembly linkage includes a link, wherein the link is pivotally connected to both the roller assembly and the rearward portion.

13. The method of claim 11, wherein the rollers are positioned in the forward portion in the folded arrangement in the unfolded arrangement

14. The method of claim 8, wherein the step of positioning the forward portion includes pivoting the forward portion approximately 180 degrees with respect to the rearward portion.

15. The method of claim 8, further comprising the step of positioning the forward portion in the folded arrangement when the first end of the rearward portion of the boom is raised with respect to the second end of the rearward portion.

16. The method of claim 8, wherein an oil drilling pipe is supported on the boom.
